(19) United States
(12) Patent Application Publication
(10) Pub. No.: US 2016/0185955 A1
(43) Pub. Date: Jun. 30, 2016

(54) Heat Resistant Polylactic Acid

(71) Applicant: Solegear Bioplastics Inc., Vancouver (CA)

(72) Inventors: Richard CHEN, Vancouver (CA); Michel LABONTE, Montreal (CA); Toby REID, Vancouver (CA)

(21) Appl. No.: 14/903,042

(22) PCT Filed: Jul. 4, 2014
(86) PCT No.: PCT/CA2014/050641

§ 371 Date: Jan. 5, 2016

Related U.S. Application Data
(60) Provisional application No. 61/843,268, filed on Jul. 5, 2013.

(51) Int. Cl. C08L 67/04; B29C 35/00; B29C 45/00; C08J 5/18

(52) U.S. Cl. CPC C08L 67/04; C08J 5/18; B29C 35/00; B29C 45/0013; C08J 2367/04; C08J 2467/02; B29K 2035/00

(57) ABSTRACT

The present disclosure provides, at least in part, a composition comprising polylactic acid (PLA), poly(butylene succinate) (PBS), and a compostable polyester such as poly(butylene adipate-co-terephthalate) (PBAT). The present compositions may comprises calcium carbonate. The present disclosure provides, at least in part, an article manufactured from present composition, such as a packaging.

### FIELD

This present disclosure relates to polylactic acid materials and, in particular, to polylactic acids with good heat resistance. The present disclosure further relates to devices, processes, methods and uses involving polylactic acid.

### BACKGROUND

Polylactic acid (PLA) offers an environmentally-friendly alternative to petroleum based plastics due to its renewability and compostability. However, PLA has a relatively low heat resistance and is considered brittle for a number of applications. An article moulded from unmodified PLA will typically deform easily at temperatures above its heat deflection temperature (HDT). This can especially be an issue for articles having thin walls (e.g. a thickness <=1 mm). A resistance to deformation under higher environmental temperatures is desirable for the shipping of the end product especially during the summer months where temperatures of a shipping container can reach up to 65° C. Load may also be applied to the article during shipping which can accelerate the deformation. Neat PLA usually shows weak properties in this regard and deforms easily.

One way to increase the HDT of PLA is by creating a composite through the addition of fillers which increase the stiffness of the material. However, this method can also reduce the impact resistance of the material, making it more brittle and unsuitable in a number of applications. Another method of increasing the HDT of PLA is to increase the crystallinity, reducing the volume of amorphous material that softens at glass transition temperature, thereby allowing the product to retain its shape at higher temperatures. Increasing crystallinity however, often requires increasing the cooling time during molding, which reduces the efficiency of the manufacturing process. Yet another method of increasing the HDT is to blend the PLA with a polymer having a higher HDT to produce a polymer blend with HDT intermediate of the two constituent polymers. This method can be ineffective due to incompatibility of the two polymers (which is required to produce intermediate properties) and can reduce the renewable content and compostability of the material.

It would be advantageous to provide a packaging material that met one or more of the following requirements: compostable, biodegradable, high in bio-based content, acceptable impact resistance, acceptable resistance to deformation (especially at elevated temperatures and/or while under load), acceptable melt flow for thin-wall injection moulding.

### SUMMARY

The present disclosure provides, at least in part, a composition comprising polylactic acid, poly(butylene succinate) and a compostable polyester.

The present disclosure provides, at least in part, a composition comprising polylactic acid (PLA), poly(butylene succinate) (PBS), and poly(butylene adipate-co-terephthalate) (PBAT).

The present disclosure provides, at least in part, a composition comprising polylactic acid (PLA), poly(butylene succinate) (PBS), calcium carbonate, and poly(butylene adipate-co-terephthalate) (PBAT).

The present disclosure provides, at least in part, an article manufactured from present composition, such as a packaging.

The present disclosure provides, at least in part, an article manufactured from the present compositions said article having an average wall thickness of 1.50 mm or less.

The present disclosure provides, at least in part, an article manufactured from the present compositions said article having a length to thickness ratio of 10 or more.

The present disclosure provides, at least in part, a PLA formulation having a heat deflection temperature of at least about 40° C. as measured by ASTM D-648.

The present disclosure provides, at least in part, a PLA film of 15 mil or 375 micron having a Gardner impact resistance as measured by ASTM D-5420 of about 0.27 J, about 0.41 J or greater, about 0.49 J or greater, about 0.55 J or greater, about 0.68 J or greater, about 0.68 J or greater, about 0.752 J or greater.

The present disclosure provides, at least in part, a PLA material having a notched izod impact resistance as measured by ASTM D-256 of about 28 J/m or greater, about 40 J/m or greater, about 60 J/m or greater, about 80 J/m or greater, about 100 J/m or greater.

The present disclosure provides, at least in part, a process for the production of the present compositions and articles.

The present disclosure provides, at least in part, biodegradable compositions.

The present disclosure provides, at least in part, compostable compositions.

As used herein, “a” or “an” means “one or more”.

This summary does not necessarily describe all features of the invention. Other aspects, features and advantages of the invention will be apparent to those of ordinary skill in the art upon review of the following description of specific embodiments of the invention.

### BRIEF DESCRIPTION OF THE DRAWINGS

FIG. 1 shows pots made from the present compositions under various loads and temperatures.

### DETAILED DESCRIPTION

The present disclosure provides, at least in part, a composition comprising polylactic acid (PLA), poly(butylene succinate) (PBS), and poly(butylene adipate-co-terephthalate) (PBAT). The present compositions may comprise calcium carbonate.

While not wishing to be bound by theory, it is believed that the present compositions show greater resistance to deformation under heat load even though the heat deflection temperature is not necessarily significantly high. When formulated into a packaging material the present compositions offer better resistance to deformation under heat and load than a HDT test would predict. It is believed that the present compositions PLA-based show advantageous properties even when the PLA is mainly amorphous even with a low cooling time. For example, the present compositions may have good heat resistance. As used herein, the term “mainly amorphous” refers to compositions showing no or low levels of crysallinity.

The present compositions are preferably compostable. The present compositions offer the ability to create a packaging material at least partially produced from renewable resources. The present compositions allow for the possibility of creating thin walled parts due to a higher melt flow.

The present compositions comprise PLA. Any suitable PLA may be used herein. The terms “polylactic acid”, “polylactide” and “PLA” are used interchangeably to include homopolymers and copolymers of lactic acid and lactide based on polymer characterization of the polymers being formed from a specific monomer or the polymers being comprised of the smallest repeating monomer units. Polylactide is a dimeric ester of lactic acid and can be formed to contain small repeating monomer units of lactic acid (actually residues of lactic acid) or be manufactured by polymerization of a lactide monomer, resulting in polylactide being referred to both as a lactic acid residue containing polymer and as a lactide residue containing polymer. It should be understood, however, that the terms “polylactic acid”, “polylactide”, and “PLA” are not necessarily intended to be limiting with respect to the manner in which the polymer is formed.

Suitable lactic acid and lactide polymers include those homopolymers and copolymers of lactic acid and/or lactide which have a weight average molecular weight generally ranging from about 10,000 g/mol to about 600,000 g/mol, from about 30,000 g/mol to about 400,000 g/mol, or from about 50,000 g/mol to about 200,000 g/mol. Commercially available polylactic acid polymers which may be useful herein include a variety of polylactic acids that are available from the Chronopol Incorporation located in Golden, Colo., and the polylactides sold under the tradename EcoPLA®. Examples of suitable commercially available polylactic acid are NATUREWORKS® from Cargill Dow and LACEA® from Mitsui Chemical. Modified polylactic acid and different stereo configurations may also be used, such as poly D-lactic acid, poly L-lactic acid, poly D,L-lactic acid, and combinations thereof.

The present compositions may comprise from about 1% or greater, about 40% or greater, about 60% or greater, about 70% or greater, by weight of the total composition, of PLA.

The present compositions may comprise from about 99% or less, about 95% or less, about 90% or less, about 85% or less, by weight of the total composition, of PLA.

The present compositions comprise one or more of a polyester made from renewable or non-renewable resources with good impact strength. Preferably the polyester is compostable. Polyesters include polymers in the class of polyhydroxyalkanoates (PHA), aliphatic copolyesters such as polybutylene succinate-co-adipate (PBSA) and polybutylene succinate-co-lactate (PBSL), aliphatic-aromatic copolyesters such as polybutylene adipate-co-terephthalate (PBAT). High impact strength-compostable polyester is not usually used in rigid packaging due to its poor strength and modulus properties even at room temperature. One preferred polyester for use herein is PBAT.

The present compositions may comprise from about 0.1% or greater, about 1% or greater, about 2% or greater, about 4% or greater, by weight of the total composition, of polyester.

The present compositions may comprise from about 40% or less, about 30% or less, about 20% or less, about 10% or less, by weight of the total composition, of polyester.

The present compositions comprise poly(butylene succinate) (PBS) or a co-polymer thereof. PBS has acceptable biodegradable and thermal resistance, but lacks the rigidity of PLA and ductility of the class of high impact strength compostable polyester The present compositions may comprise from about 1% or greater, about 5% or greater, about 10% or greater, about 15% or greater, by weight of the total composition, of PBS.

The present compositions may comprise from about 60% or less, about 50% or less, about 40% or less, 30% or less, by weight of the total composition, of PBS.

The present compositions may comprise calcium carbonate. Any suitable amount of calcium carbonate may be used herein. The present compositions may comprise at least about 0.1%, at least about 1%, about 2%, about 3%, about 4%, about 5%, about 6%, by weight, of calcium carbonate. The present compositions may comprise about 40% or less, about 20% or less, about 15% or less, about 12% or less, by weight, of calcium carbonate.

The present compositions may comprise a variety of optional ingredients. It is preferred that any additive be compostable and/or biodegradable. The present compositions may comprise an impact modifier. Any suitable impact modifier may be used such as, for example, core shell acrylic elastomers. The present impact modifier may be selected from, for example, Sukano im633 (Sukano), PARALOID BPM-515 (Arkema), or the like. In certain embodiments the present compositions comprise from about 0.1% to about 20%, from about 1% to about 10%, from about 2% to about 8%, by weight, of impact modifier. The present compositions may comprise a plasticizer. Any suitable plasticizer may be used such as, for example, triethyl citrate, tributyl citrate, glycerol, lactic acid monomer and oligomer. In certain embodiments the present compositions comprise from about 0.01% to about 20%, from about 0.1% to about 10%, from about 0.5% to about 8%, from about 0.8% to about 5%, from about 1% to about 4%, by weight, of plasticizer.

Other optional materials include, for example, processing aids to modify the processability and/or to modify physical properties such as elasticity, tensile strength and modulus of the final product. Other optional materials may include, but are not limited to, those which provide stability including oxidative stability, brightness, color, flexibility, resiliency, workability, processing aids, viscosity modifiers, and odor control.

Examples of other optional ingredients include, but are not limited to, gum arabic, bentonite, salts, slip agents, crystallization accelerators or retarders, odor masking agents, cross-linking agents, emulsifiers, surfactants, cyclodextrins, lubricants, other processing aids, optical brighteners, antioxidants, flame retardants, dyes, pigments, fillers, proteins and their alkali salts, waxes, tackifying resins, extenders, chitin, chitosan, and mixtures thereof. Suitable optional fillers include, but are not limited to, clays, silica, mica, wollastonite, calcium hydroxide, sodium carbonate, magnesium carbonate, barium sulfate, magnesium sulfate, kaolin, calcium oxide, magnesium oxide, aluminum hydroxide, talc, titanium dioxide, cellulose fibers, chitin, chitosan powders, organosilicone powders, nylon powders, polyester powders, polypropylene powders, starches, and mixtures thereof. When used, the amount of filler is generally from about 0.01% to about 60% by weight of the composition.

The present disclosure provides a packaging material made from the present compositions. The packaging material may have any suitable thickness. For example, the present packaging material may have a thickness of about 0.1 mm or more, about 0.2 mm or more, about 0.3 mm or more, about 0.4 mm or more, about 0.5 mm or more, about 0.6 mm or more, about 0.7 mm or more, about 0.8 mm or more, about 0.9 mm or more, about 1 mm or more. The present packaging may have a thickness of about 5 mm or less, about 4.5 mm or less, about 4 mm or less, about 3.5 mm or less, about 3 mm or less, about 2.5 mm or less, about 2 mm or less.

The present disclosure provides a packaging material made from the present compositions. The packaging material may have a length to thickness ratio of about 10 or more, about 30 or more, about 50 or more, about 100 or more, about 200 or more.

The present disclosure provides, at least in part, a PLA film of 15 mil or 375 micron having a Gardner impact resistance as measured by ASTM D-5420 of about 0.27 J, about 0.41 J or greater, about 0.49 J or greater, about 0.55 J or greater, about 0.68 J or greater, about 0.68 J or greater, about 0.752 J or greater.

The present disclosure provides a material having a notched izod impact resistance as measured by ASTM D256 of about 28 J/m or greater, about 40 J/m or greater, about 60 J/m or greater, about 80 J/m or greater, about 100 J/m or greater.

It is preferred that the moisture content of the PLA composition be about 1% or less by weight of the PLA composition. For example, about 0.8% or less, about 0.6% or less, about 0.4% or less, about 0.2% or less, about 0.1% or less. The requisite moisture content may be achieved in any suitable manner. For example, the PLA composition may be dried under a vacuum.

The present disclosure optionally provides a compostable and/or biodegradable composition. Biodegradable polymers are those wherein the organic polymers molecules present in the composition break down into harmless, environmentally acceptable, chemicals such as water, carbon dioxide and sometimes methane. This may occur, for example, through an anaerobic process under certain compost conditions. The decomposition of polymers under compost conditions is usually achieved in the presence of soil, moisture, oxygen and enzymes or microorganisms. The American Society for Testing and Materials (ASTM) has established ASTM D-6400 entitled “Standard Specification for Compostable Plastics”. The compositions herein preferably meet or exceed the requirements of this method. Other ASTM methods of interest in assessing the present disclosure include ASTM D-6002, ASTM D-6868, ASTM D-5511, and ASTM D-5526. Preferably the polymers of the present disclosure have greater than 50% disintegration within 28 days under anaerobic conditions and, in further embodiments, greater than 60%, or greater than 80% disintegration in 28 days under such conditions (accelerated landfill conditions). Anaerobic biodegradation is the disintegration of organic material in the absence of oxygen to yield methane gas, carbon dioxide, hydrogen sulphide, ammonia, hydrogen, water and a compost product suitable as a soil conditioner. It occurs as a consequence of a series of metabolic interactions among various groups of microorganisms in the anaerobic medium (sludge). The total solids concentrations in the test sludge are over 20% (35%, 45%, and 60%) and the pH is between 7.5 and 8.5. The test takes place at a mesophilic temperature (35±2° C.) with mixed inoculums derived from anaerobic digesters operating only on pretreated household waste (ASTM D-5526).

The present disclosure provides a process for the production of a PLA composition.

The compositions herein may be used to form a molded or extruded article. As used herein, a “molded or extruded article” is an object that is formed using molding or extrusion techniques such as injection molding, blow molding, compression molding or extrusion of pipes, tubes, profiles, cables, or films. Molded or extruded articles may be solid objects such as, for example, toys, or hollow objects such as, for example, bottles, containers, tampon applicators, applicators for insertion of medications into bodily orifices, medical equipment for single use, surgical equipment, or the like. See Encyclopedia of Polymer Science and Engineering, Vol. 8, pp. 102-138, John Wiley and Sons, New York, 1987 for a description of injection, compression, and blow molding. See Hensen, F., Plastic Extrusion Technology, p 43-100 for a description of extrusion processes.

It is contemplated that the different parts of the present description may be combined in any suitable manner. For instance, the present examples, methods, aspects, embodiments or the like may be suitably implemented or combined with any other embodiment, method, example or aspect of the invention.

Unless defined otherwise, all technical and scientific terms used herein have the same meaning as is commonly understood by one of ordinary skill in the art to which this invention belongs. Unless otherwise specified, all patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference. Citation of references herein is not to be construed nor considered as an admission that such references are prior art to the present invention.

Use of examples in the specification, including examples of terms, is for illustrative purposes only and is not intended to limit the scope and meaning of the embodiments of the invention herein. Numeric ranges are inclusive of the numbers defining the range. In the specification, the word “comprising” is used as an open-ended term, substantially equivalent to the phrase “including, but not limited to,” and the word “comprises” has a corresponding meaning.

The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

### Examples

PLA (NATUREWORKS Ingeo 3251D), PBS/calcium carbonate, and PBAT are formulated into compositions based on the formulations listed in Table 1. Prior to processing, all materials are pre-dried in a dessicant oven at 80 C for at least 6 hours. The materials are compounded by feeding the components through a gravity feeder into a twin screw extruder where materials are melt extruded. The twin screw extruder employed is a Leistritz 27 mm, MIC27/GL-32D, 1995. Compounding is conducted at a temperature range of 180-195 C ascending through the length of the extruder, water cooled, and pelletized to obtain pellets of the formulation.

Injection moulding is conducted on a Engel 85 ton injection moulder, model 330/85, equipped with tooling for flexural and tensile bars with the dimensions as provided in ASTM D790 and ASTM D638 respectively. Following injection moulding into test samples, all bars are conditioned at room temperature and 50% relative humidity for 40 hours prior to any testing.

Samples for thermal resistance during application are injection moulded using a mould for an article with a wall thickness of approximately 1.4 mm and a ‘length’ to thickness ratio of approximately 100. Where the ‘length’ is the distance between the gate of the mould, to a point furthest from the gate of the mould.

Tensile properties are determined as per ASTM D638 on a Universal Testing Machine MTS Criterion, Model 43. The test is conducted with a 50 kN load cell, at 5 mm/min on a type 1 tensile specimen.

Izod notched impact resistance is determined as per ASTM D256 on a Monitor Impact Tester, model 43-02-01-0001, with a 5 lb impact pendulum.

Heat deflection temperature is determined as per ASTM D648 on a Ceast HDT 6 Vicat, Model 692, with a Dow Corning oil 200/100 and a load of 0.45 MPa at a heating rate of 2 C/min.

Melt flow index is determined as pet ASTM D1238 on a Tinius Olsen Extrusion Plastometer, model MP993a at temperature of 190 C with a load of 2.16 kg.

Table 2 provides a summary of the results. Properties of Examples 1 and 3 are produced based on the testing methods outlined above, while data for PP, PBS, and neat PLA are obtained from information published by manufacturer.

TABLE 1
Formulations

| Materials Tested | |
|---|---|
| Example 1 | PLA (Ingeo 3251D) 80 wt %, PBS 20 wt %, |
| | 5% calcium carbonate, PBAT 15 phr, carbon |
| | black 1 phr |
| Example 2 | PLA (Ingeo 3251D) 80 wt %, PBS 20 wt %, |
| | 7% calcium carbonate, PBAT 8 phr, carbon |
| | black 1 phr |
| Example 3 | PLA (Ingeo 3251D) 70 wt %, PBS 30 wt %, |
| | 10% calcium carbonate, PBAT 15 phr, carbon |
| | black 1 phr |
| Comparative | PLA (Ingeo 3251D), impact modifier CC10122525FB |
| Example 1 | 5%, mold release |
| PP | Polypropylene |
| Neat PLA | PLA (Ingeo 3251D) |

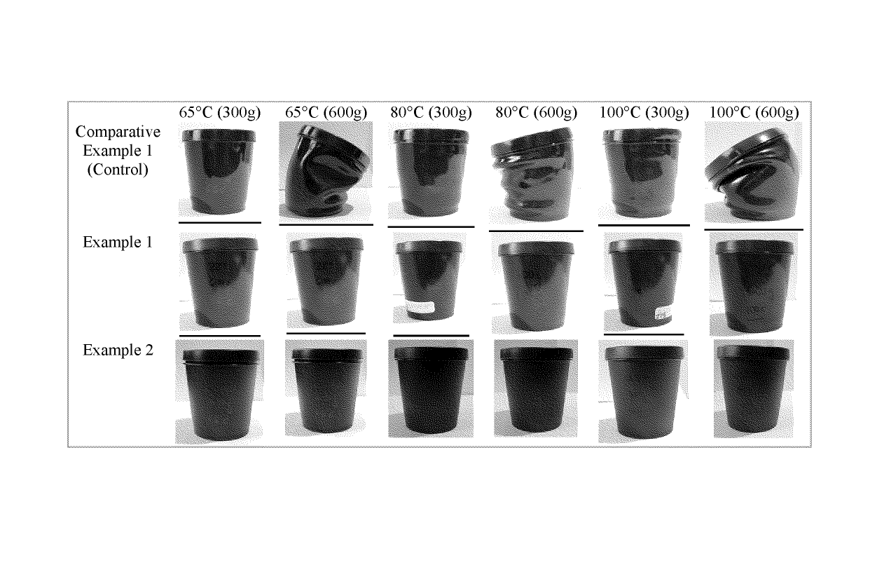

The articles are tested for temperature resistance under load. This experiment is carried out in order to simulate the shipping conditions of the material during application. The pots are filled with 250 g of a solid material, placed in an oven at 65° C., 80° C. and 100° C. and loaded with a weight of either 300 g or 600 g. The results are shown in FIG. 1.

The tested compositions according to the present disclosure show good resistance to deformation under elevated temperature compared to predominately PLA based formulation, FIG. 1: Comparative Example 1. Articles made from Comparative Example 1 tend to buckle at higher temperature and higher loads, while Articles produced from Example 1 and 2 are able to withstand higher temperature and loads. The compositions have acceptable compostability, bio-based content, impact resistance, and melt flow for thin-wall injection moulding.

TABLE 2
Property Testing

| | Example 1 | Example 3 | PP | PBS | Neat PLA |
|---|---|---|---|---|---|
| Tensile strength | 6300 | 5660 | 5660 | 4100 | 9000 |
| [psi] | | | | | |
| Tensile Modulus | 411,000 | 382,000 | 235,000 | 156,000 | 540,000 |
| [psi] | | | | | |
| Elongation | >20 | >20 | >20 | 16.3 | 3.5 |
| [%] | | | | | |
| Impact | 0.75 | 1.01 | 0.56 | 0.35 | 0.3 |
| [ft * lbs/in] | | | | | |
| HDT (0.45 MPa) | 50.1 | 50.5 | 110 | Not listed | 55 |
| [° C.] | | | | | |
| MFI (190 C., 2.16 kg) | 31.1 | 28.0 | 12 | 15.5 | 35 |
| [g/10 min] | | | | | |

Calcium carbonate has a loading range of between 2 to 20 wt % in the overall formulation. A crystallinity study was done using a differential scanning calorimeter (DSC) with a heat/cool/heat cycle. The first heating cycle was done at a ramp rate of 10° C./min from 0° C. to 180° C. to remove any thermal history that has been imparted on the material by any processing. The cool cycle was done at a ramp rate of 10° C./min from 180° C. to 0° C. to study the cooling behavior of the material. The second heating was done at a ramp rate of 10° C./min from 0° C. to 180° C. to observe glass transition, cold crystallization, and melting behaviors.

Formulation 228 which is composed of PLA, PBAT and Carbon black showed crystallization during cooling with an exothermic peak at 95.09° C. 2nd heating cycle showed that formulation 228 does not have any cold crystallization because it has already obtain the achievable crystallinity during cooling. While PLA is not known for high rate of crystallinity, the addition of carbon black may have worked as a nucleating effect, enhancing the crystallization rate during cooling.

Formulation 225A-N, which is a uncolored version of formulation 225A, showed no crystallization during cooling which may have been anticipated due to the low crystallization rate of PLA which is not enhanced by the addition of carbon black as it was in 228.

However, since Danimer is known to contain CaCO₃, one would expect crystallization to be observed due to the known nucleating effect of CaCO₃ on PLA. Heating showed cold crystallization and some rearrangement of polymer chains at 88.03° C., and melting at approximately 165° C.

Formulation 225A-B, is a carbon black filled version of formulation 225A. From the previously observed effect of carbon black on formulation 228, one would expect cooling to show a crystallization peak, which was again not observed although both carbon black and calcium carbonate are known nucleating agents for PLA. Heating showed similar behavior as the uncolored version of 225A.

This result showed that the formulation 225A-N and 225A-B is likely not crystalline during the typical injection moulding process to produce the part. The cooling time where PLA would have crystallized as observed in formulation 228 is approximately 2 minutes or more based on the ramp rate and the crystallization peak. This indicates that within the typical injection moulding cycle time of less than 1 minute, which was used to produce the part, crystallization is less likely to occur.

1. A composition comprising polylactic acid, poly(butylene succinate) and a compostable polyester.

2. The composition of claim 1 wherein the composition comprises calcium carbonate.

3. The composition of claim 1 comprising at least 40% by weight of polylactic acid.

4. The composition of claim 1 comprising at least 5% by weight of poly(butylene succinate).

5. The composition of claim 1 wherein the composition comprises from about 0.1% to about 40% by weight of calcium carbonate.

6. The composition of claim 1 comprising from about 40% to about 99% by weight of polylactic acid.

7. The composition of claim 1 comprising from about 5% to about 60% by weight of poly(butylene succinate).

8. The composition of claim 1 comprising from about 0.1% to about 40% by weight of the polyester.

9. The composition of claim 1 wherein the compostable polyester is selected from polyhydroxyalkanoates, aliphatic copolyesters, aliphatic-aromatic copolyester, or combinations thereof.

10. The composition of claim 1 wherein the compostable polyester is selected from polybutylene adipate-co-succinate, polybutylene adipate-co-lactate, polybutylene adipate-co-terephthalate, or combinations thereof.

11. The composition of claim 1 wherein the compostable polyester is polybutylene adipate-co-terephthalate.

12. A method of producing an article, the method comprising:
(a) providing a composition according to claim 1;
(b) heating said composition to a temperature above its melt temperature;
(c) extruding said composition into a film;
(d) placing the heated film in a mould; and
(e) cooling to below melt temperature

13. A method of producing an article, the method comprising:
(a) providing a composition according to claim 1;
(b) heating said composition to a temperature above its melt temperature; and
(c) injection moulding said article.

14. The film according to claim 12 wherein said film has impact resistance as measured by ASTM D-5420 a PLA film of 15 mil or 375 micron having a Gardner impact resistance as measured by ASTM D-5420 of about 0.27 J, about 0.41 J or greater, about 0.49 J or greater, about 0.55 J or greater, about 0.68 J or greater, about 0.68 J or greater, about 0.752 J or greater.

15. The article according to claim 13 wherein said article has a notched izod impact resistance as measured by ASTM D-256 of about 28 J/m or greater, about 40 J/m or greater, about 60 J/m or greater, about 80 J/m or greater, about 100 J/m or greater.

16. A composition according to claim 1 wherein the moisture content about 1%, by weight, or less.

17. A composition according to claim 1 wherein the article is ASTM D-6400 compliant.

18. A composition according to claim 1 wherein the article disintegrates by about 50% or more within 28 days under the conditions specified in ASTM D-5526.

19. An article comprising the composition of claim 1 wherein said article has an average thickness of about 0.2-5.0 mm, about 0.4-4.0 mm, about 0.6-3.0 mm, about 1.0-2.0 mm.

20. An article comprising the composition of claim 1 wherein said article has a length to thickness ratio of about 10 or greater, about 30 or greater, about 50 or greater, about 100 or greater, about 200 or greater.
